(19) United States
(12) Patent Application Publication
(10) Pub. No.: US 2019/0202682 A1
(43) Pub. Date: Jul. 4, 2019

(54) Transportable Module for a Fluid Loading Arm and Controller

(71) Applicant: FMC Technologies, Sens (FR)

(72) Inventors: Raphael Poichot, Auxerre (FR); Eric Morilhat, Villeneuve-Sur-Yvonne (FR)

(21) Appl. No.: 16/328,685

(22) PCT Filed: Sep. 1, 2017
(86) PCT No.: PCT/EP2017/071989

§ 371 Date: Feb. 26, 2019

(30) Foreign Application Priority Data
Sep. 1, 2016 (FR) 1658145

(51) Int. Cl. B67D 9/02; B63B 27/25; B63B 9/06

(52) U.S. Cl. CPC B67D 9/02; B63B 9/06; B63B 27/25

(57) ABSTRACT

Displacing module (1) for displacing from a first location to a second location a fluid transfer system (2) having one or several fluid loading arms. The displacing module comprises a carrying structure (11) to be fastened at the second location, on which is mounted the fluid transfer system (2), and which furthermore carries control means (16, 17, 19, 22) for moving the loading arms, and which are functionally linked thereto.

The present invention generally relates to fluid transfer systems, and more particularly marine loading systems, in particular such as articulated loading arms or loading systems of the type with a flexible pipe, for the transfer of a fluid from one location to another (loading and/or unloading).

Fluid is understood herein to mean a liquid or gaseous product, such as a petroleum, gas or chemical product. It is more particularly liquefied natural gas or low or high pressure natural gas. This type of product is to be transferred, for example, between a ship and a quay or jetty or between two ships.

For marine loading systems, it may be:

Conventional marine loading arms such as defined for example in the patent applications FR2813872, FR2854156, and FR2931451;

Marine loading arms without a base such as defined for example in the patent application FR2964093;

Bunkering arms such as defined for example in the patent application FR3003855;

Loading arms enabling low connection points to be attained, of the kind defined in the patent U.S. Pat. No. 3,249,121;

Loading systems with a flexible pipe such as defined for example in the patent application FR2968058; and

Hybrid loading systems (a rigid part and a flexible part), such as defined for example in the patent application FR3003855.

The manufacturers of such transfer systems are increasingly confronted with a demand to reduce the time on site for installation and reception of these.

The present invention is directed to providing a system meeting that demand and furthermore leading to other advantages.

To that end, it provides a displacing module for displacing a fluid transfer system from a first location to a second location, characterized in that it comprises a carrying structure to be fastened to the second location, on which is mounted the fluid transfer system, and which furthermore carries control means of the fluid transfer system, which are functionally linked thereto.

In practice, the displacing module is a displacing module for displacing a fluid transfer system having one or several fluid transfer elements from a first location to a second location, characterized in that it comprises a carrying structure to be fastened to the second location, on which is mounted the fluid transfer system, and which furthermore carries control means for controlling means for putting the fluid transfer element or elements of the fluid transfer system in motion, and which are functionally linked thereto.

By virtue of these provisions, it is possible to substantially reduce time on site for installation and reception, in particular due to the fact that the number of components of the system still to be connected at the time of the installation on site and the number of linking points at the site are appreciably reduced.

Furthermore, the pre-mounting of the system and of the control means on the carrying structure may be carried out during the construction of a ship and it is not therefore necessary to wait for the end of the construction thereof to perform the assembly of the transfer system and of its control means.

Furthermore, such a module makes it possible to displace the transfer system from a first site of use to a second site of use, when use on the first site is of no further interest.

The fluid transfer element or elements of the module according to the present invention are e.g. a flexible duct or the transfer elements of an articulated arm. The means of this module for putting its transfer element(s) in motion are e.g. hydraulic, electric or pneumatic actuators.

According to other provisions of the present invention, which may be implemented independently or in combination, in particular for reasons of convenience of manufacture or use:

The carrying structure comprises fastening means for fastening it, removably, at the second location;

The control means comprise hydraulic, pneumatic, or electrical energy supply means for supplying energy to the fluid transfer system;

The hydraulic energy supply means comprise a hydraulic power system, at least one set of selecting valves and backup hydraulic accumulators;

The transfer system comprises electrical actuators and the electrical energy supply means comprise the electrical equipment necessary for controlling the electrical actuators;

The means for putting the fluid transfer element or elements in motion comprise pneumatic actuators and the pneumatic energy supply means comprise a pneumatic power system and means for driving the pneumatic actuators.

The control means further comprise a control panel for controlling the fluid transfer system, which is functionally linked to the energy supply means;

The module further comprises an equipment space, which is pressurized, and the control means comprise a computing and data acquisition device installed in the space;

The control panel and/or the electrical equipment is or are also installed in the space;

The module further comprises at least one additional equipment item chosen from the group comprising a removable length of piping, a flow measuring device, a process monitoring device, motor-actuated valves, ship-to-ship links and a device for monitoring position of the transfer system;

The carrying structure comprises a platform;

The carrying structure is provided with raising means for raising that structure as well as the components installed thereon;

The means for raising the carrying structure comprise hooking means for hooking to a raising apparatus;

The fluid transfer system comprises at least one marine loading system.

The disclosure of the present invention will now be continued with the detailed description of embodiments, given below by way of non-limiting illustration, with reference to the appended drawings.
In these:

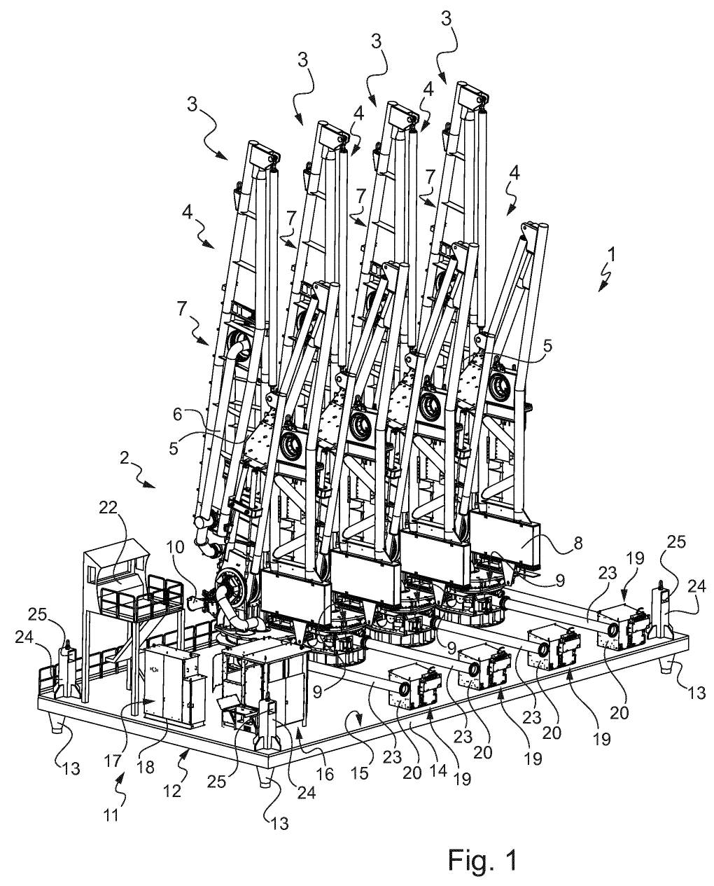

FIG. 1 is a diagrammatic perspective view of a module in accordance with a first embodiment of the present invention;

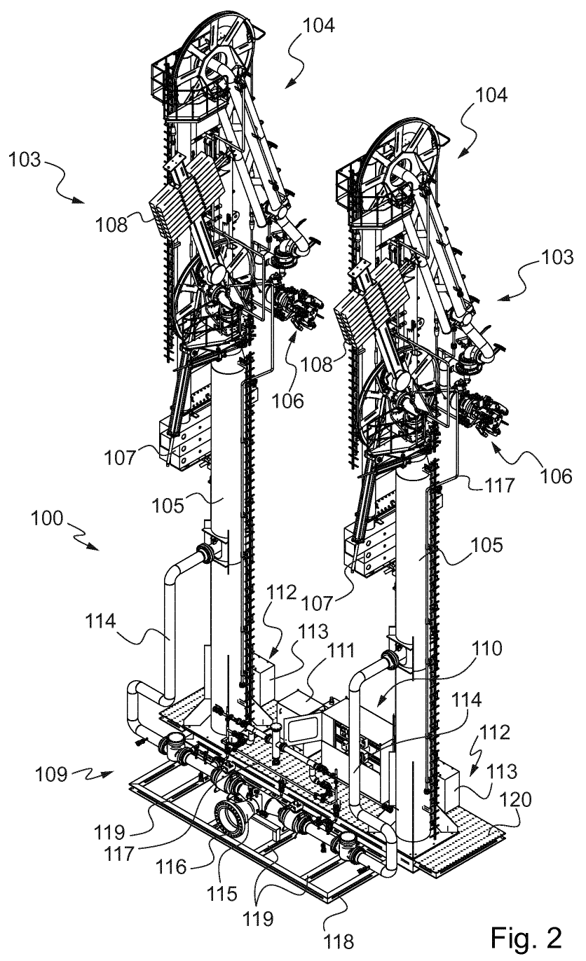

FIG. 2 is a perspective view of a module in accordance with a second embodiment of the present invention;

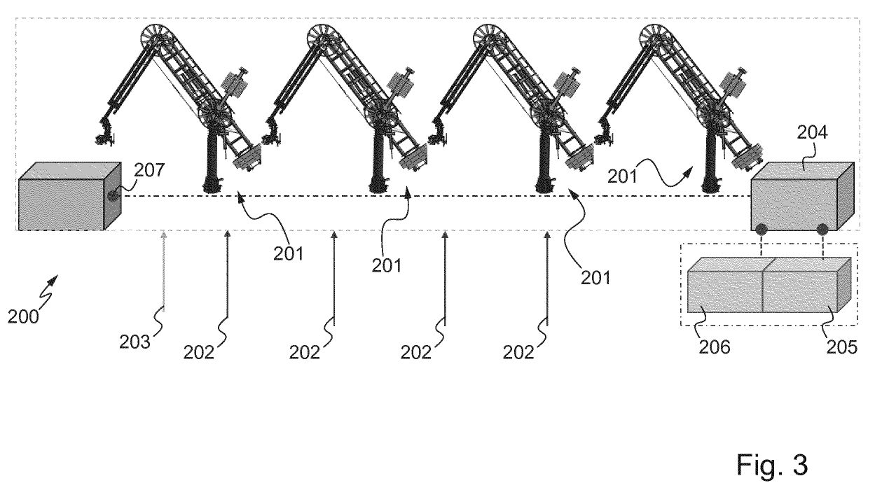

FIG. 3 is a diagram representing the connections and interfaces of a module according to another embodiment of the invention;

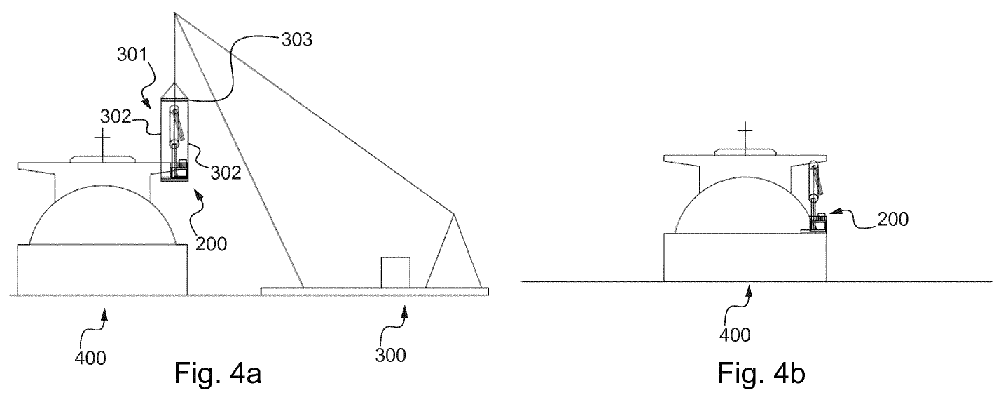

FIGS. 4a and 4b diagrammatically represent the installation of a module of the kind in FIG. 3 in a methane tanker ship by means of a crane pontoon.

FIG. 1 diagrammatically represents a displacing module 1 for displacing a fluid transfer system 2 from a first location to a second location, according to a first embodiment of the invention.

For the first location, this may for example be a unit for manufacturing the fluid transfer system and, for the second location, a quay, a jetty or a ship.

The fluid transfer system 2 here comprises four identical balanced arms 3 for fluid transfer, with no base. The fluid here is liquefied natural gas. Each of these arms 3 comprises a transfer compass 4 comprising an inner transfer member 5 and an outer transfer member 6, articulated together and carried by a support structure 7. Each arm 3 further comprises a counterweight system 8 for balancing the transfer compass 4. The compass is installed on a turntable 9 rotatable about a vertical axis, to rotationally drive the transfer compass 4 about that axis. Moreover, the outer transfer member 6 carries a coupling assembly 10 enabling the transfer of the fluid, which is to be connected to a target duct, such as a manifold, disposed for example on a ship.

As these are arms which are known per se, they will not be described here in more detail.

It will simply be noted that this kind of articulated marine loading arm is in particular described in the patent application FR2964093 identified supra.

In practice it is an offshore loading arm commercialized by the applicant under the name “OLAF”.

In accordance with the present invention, the fluid transfer system 2, here comprising the four marine loading arms 3 with no base, is mounted on a carrying structure 11 of the displacing module 1. In practice, this is a platform 12 to which are fastened the turntables 9 of each of the loading arms 3.

This platform 12 comprises means for removably fastening the module 1 to the second location (quay, jetty, ship). Here, these are feet 13 arranged at each corner of the platform. As a variant, they may be equivalent interface parts.

These feet 13 may, for example, be fastened by welding to the deck of a ship. As a variant, the platform may, for example, be fastened by bolting to the second location with a view, for example, to displacing it to another location at the end of use on the deck of that ship or another second location.

In practice, this platform 12 comprises a chassis having a rectangular frame 14 to which several metal plates 15 are fastened, for example by welding. Metal girders that cross each other are also provided, here, to reinforce the frame and provide fastening points for the loading arms 3. These are not visible in FIG. 1 due to the fact that they are fastened to the sides of the frame 14 below the metal plates 15.

In the case of the present embodiment, these girders are arranged over half of the width of the platform carrying the arms and are fastened, by welding, to the three corresponding sides of the frame.

As a variant, they could of course be fastened to the four sides of the frame and extend over the entire width of the platform.

In accordance with the present invention, the carrying structure 11 of the displacing module furthermore carries control means for those loading arms 3, functionally linked to them.

As these are loading arms with hydraulic actuators here (for example jacks), the control means comprise means for supplying hydraulic energy. These means for supplying hydraulic energy comprise, more specifically, a hydraulic power system 16, backup hydraulic accumulators 17 housed in a cabinet 18 fastened to the platform 12, as well as a set of selecting valves 19 for each of the arms. Each of these valve assemblies is housed in a box 20 fastened to the platform.

As is known per se, the hydraulic power system 16 is operative to provide the hydraulic energy serving to operate the control valves, the jacks and the hydraulic motors of the transfer system 2.

As is known per se, each set of selecting valves 19 serves to distribute the hydraulic energy received from the hydraulic power system to the hydraulic actuator or hydraulic actuators to be operated. As regards the backup hydraulic accumulators 17, as is also known per se, these are provided to supply the hydraulic energy necessary a minima for an emergency disconnect in the case of an electrical fault.

The control means of the present embodiment of the invention further comprise a computing and data acquisition device which is, in the case of this embodiment, a programmable logic controller (or PLC). This controller serves in particular to control the hydraulic power system 16 and the sets of selecting valves 19 via a control panel 22. It is configured to process signals received from measuring means, each associated with loading arms, by means of pre-programmed algorithms. It is furthermore housed, here, in a dedicated electrical room situated on the ship, the quay or the jetty where the present module 1 comes to be installed. A distribution control system (or DCS) is also housed therein and functionally linked to the controller.

A remote control interface, associated with that control panel, may also be provided to enable an operator to operate the arms from the base of the platform 12. As a matter of fact, as can be seen in FIG. 1, the control panel 22 is, here, installed high up.

In other embodiments, a pressurized equipment space could be mounted on the platform 12 in order to receive the computing and data acquisition device. The control panel may also be installed in that space.

The various components of the electro-hydraulic system so formed are of course connected to each other by electrical cables as well as pipes for supplying the arms with fluid from the hydraulic power system 16 or from the backup accumulators 17. These connection means are not visible in FIG. 1 since they are mounted under the plates 15. The inner and outer transfer members 5 and 6 of each of these arms are to be linked, for the transfer of fluid, to product lines arranged on the ship, the quay or the jetty where the displacing module 1 comes to be installed. Each of the arms thus also comprises, in the case of the present embodiment, a product line 23 to be linked to one of the aforementioned ones, with a valve being interposed (here the lines 23 represent 3 incoming fluid lines and one vapor return line).

It may also be provided to connect an incoming nitrogen line enabling the lines for nitrogen purging of the arms 3 according to provisions also known per se. This line may also serve for drying the articulations of the arms 3.

It will also be noted that the dimensions of such a platform, in practice, are of the order of 22 meters in length by 7 meters in width.

Thus, by virtue of the displacing module 1 of the present invention and as will be seen in more detail below, the only connections necessary once the module 1 has been installed on site, are those of the product lines, of the incoming nitrogen line and of the electrical supply of the control panel, of the hydraulic power system as well as of the backup accumulators.

Furthermore, the number of connection points at the installation site is relatively limited in that it suffices to fasten the feet, for example to the deck of the ship.

Furthermore, a single raising operation suffices to install the displacing module 1 on its destination site.

What is more, it will have been possible for the displacing module 1 to have been pre-mounted during the construction of a ship and thus it will have been possible for part of the assembly to have been made without awaiting the end of the construction thereof.

All this considerably reduces the on-site installation time of the transfer system 2. In particular, the time necessary for cabling is not only reduced, but also simplified. The turnkey transfer system 2 of the present invention also proves to be particularly compact.

Furthermore, in order to bring, for example, this module 1 from the location of manufacture to the deck of a ship where it is intended to be installed, the carrying structure 11 is provided with means enabling it to be raised. In practice, in the case of the embodiment of FIG. 1, these are posts 24 mounted in each of the four corners of the platform 12 and which are each provided with hooking means for hooking to a raising apparatus.

In practice, this is the apex of each post 24 which is passed through by an opening 25 for passage of a cable or a sling of a crane.

According to a second embodiment represented in FIG. 2, the displacing module 100 employs, as fluid transfer system, two articulated arms for loading and unloading fluid product 103, for example such as natural gas at high pressure.

These arms are of the double counterweight type, as described in the aforementioned patent application FR2813872.

They will not therefore be described in more detail here.

It will simply be noted that they are articulated arms having a duct compass 104 mounted by one of its ends on a base 105 and which is provided at the other of its ends with a connecting system 106 for connecting the duct compass to a complementary coupling means. It is furthermore balanced by a system with two counterweights 107, 108.

They make it possible for example to transfer the gas from a methane tanker to tanks or to a dedicated network of piping installed on a jetty or near to it.

The two arms 103 are mounted on a platform 109 on which are also mounted the hydraulic power system 110, the backup accumulators 111 as well as the two assemblies of selecting valves 112 mounted in boxes 113 also fastened to the platform.

It will also be noted that the two pipes 114 connected to the duct compass 104 of each of these arms, at the location of their base 105, meet at a common duct 115 incorporating a valve and provided with a half-coupling 116 for the connection of a product line. A depressurization network 117, known per se, is also provided here.

Furthermore, the platform 109 comprises a lower part based on a rectangular frame 118 and parallel girders 119 meeting the two longitudinal sides of the frame 118 and a plate 120 rigidly fastened to the frame 118. This plate 120 forms a main part of the module 100 since it carries the arms 103 and the hydraulic and electrical equipment, while the frame 118 forms an auxiliary part for supporting piping of the product lines (pipes 114) and for supplementary functions, such as the lines of the depressurization network 117.

In practice, the maximum length of the platform 109 is 12 meters for a width of 6 meters.

In the case of this embodiment, the programmable logic controller and the control panel are not mounted on the platform 109 but directly on the location receiving the latter.

FIG. 3 represents the connection points necessary for a module 200 according to another embodiment of the invention, represented very diagrammatically and carrying four articulated loading and unloading arms 201 forming a fluid transfer system and which is of the type described in the aforementioned application FR2813872. As can be seen, it suffices to connect a product line 202 to each of the arms as well as a nitrogen purge line 203 supplying each of the arms, and connect a pressurized space 204 incorporating a programmable logic controller and a control panel with an energy supply 205 and a client DCS 206, installed in a safe zone of the location at which the module is ultimately installed, such as the deck of a ship.

It will furthermore be observed that, as for the preceding embodiments, this module 200 carries a power unit, power accumulators and sets of selecting valves, diagrammatically represented at 207 and supplied with energy via the energy supply of the pressurized space 204.

As can be seen in FIGS. 4a and 4b, a crane pontoon 300 may be implemented to displace and install such a module 200 on a methane tanker 400. To that end, a raising structure 301 comprising cables 302 fastened temporarily to the module 200 and connected to a transverse bar 303 may be employed. This bar is hooked to the crane pontoon to raise the displacing module 200 onto the deck of the ship 400. Once the installation has finished, this temporary raising structure 301 is removed, as can be seen in FIG. 4b.

It will furthermore be noted that, in the case of an electrical arm, that is to say an arm comprising electrical actuators, the electrical energy supply means, installed for example on the module, comprise the electrical equipment necessary for controlling the electrical actuators, for example such as drives, filters and inductors.

The control panel is, in this case, linked to the electrical equipment. It may be installed with the electrical equipment in a pressurized space.

In the case where the means for putting the fluid transfer element(s) (in particular the inner and outer transfer members 5, 6 described above) in motion are pneumatic actuators, the pneumatic energy supply means comprise a pneumatic power system and means for driving the pneumatic actuators, for example such as pumps, compressors and distributors.

Numerous other variants are possible according to circumstances, and in this connection it is to be noted that that the present invention is not limited to the examples represented and described.

In particular, marine loading arms implemented in the three embodiments described supra may be replaced by any other fluid transfer system of the kind also described supra.

Equally, the carrying structure may be fastened to the second location by any other fastening method equivalent to welding or bolting.

As regards the programmable logic controller, this may be replaced, for example, by a computing and data acquisition device.

Moreover, other functions may be made available on the module (outside or in the equipment space), such as:

a water curtain, for example such as used on FLNGs (FLNG standing for Floating Liquefied Natural Gas) and FSRUs (FSRU standing for Floating Storage Regazeification Unit) to prevent the liquefied natural gas from spilling and damaging the lateral part of the hull;

a removable portion of piping (used on FLNGs and FSRUs to switch vapor arm);

a flow metering device (in-line metering of the liquefied natural gas transfer);

a process monitoring device (in-line pressure and temperature monitoring, in communication with the DCS);

motor operated valves (open in offloading position and closed in holding position);

ship-to-ship links (used between the FSRU/FLNG and the LNG carrier for side-by-side transfer), such as links for emergency shutdown (ESD), public address general alarm (PAGA) or telephone;

a position monitoring system (PMS) for monitoring the position of the transfer system and for alarm triggering if necessary.

1: A displacing module for displacing a fluid transfer system from a first location to a second location, the fluid transfer system having a number of fluid transfer elements, the displacing module comprising a carrying structure which is configured to be fastened to the second location and on which is mounted the fluid transfer system, the carrying structure carrying control means for controlling means for putting the fluid transfer elements in motion, the control means being functionally linked to the fluid transfer elements.

2: The displacing module according to claim 1, wherein the carrying structure comprises fastening means for removably fastening the carrying structure to the second location.

3: The displacing module according to claim 1, wherein the control means comprises a hydraulic, pneumatic, or electrical energy supply means for supplying energy to the fluid transfer system.

4: The displacing module according to claim 3, wherein the hydraulic energy supply means comprises a hydraulic power system, at least one set of selecting valves, and backup hydraulic accumulators.

5: The displacing module according to claim 3, wherein the means for putting the fluid transfer elements in motion comprises electrical actuators and the electrical energy supply means comprises electrical equipment necessary for controlling the electrical actuators.

6: The displacing module according to claim 3, wherein the means for putting the fluid transfer elements in motion comprises pneumatic actuators and the pneumatic energy supply means comprises a pneumatic power system and means for driving the pneumatic actuators.

7: The displacing module according to any one of claims 3 to 6, wherein the control means further comprises a control panel for controlling the fluid transfer system, the control panel being functionally linked to the energy supply means.

8: The displacing module according to claim 7, further comprising a pressurized equipment space, wherein the control means comprises a computing and data acquisition device installed in the equipment space.

9: The displacing module according to claim 8, wherein at least one of the control panel and the electrical equipment is installed in the equipment space.

10: The displacing module according to claim 1, further comprising at least one additional equipment item chosen from the group consisting of a removable length of piping, a flow metering device, a process monitoring device, motor-operated valves, ship-to-ship links and a device for monitoring position of the transfer system.

11: The displacing module according to claim 1, wherein the carrying structure comprises a platform.

12: The displacing module according to claim 1, wherein the carrying structure is provided with raising means for raising the carrying structure and the components installed thereon.

13: The displacing module according to claim 12, wherein the means for raising the carrying structure comprise hooking means for hooking the carrying structure to a raising apparatus.

14: The displacing module according to claim 1, wherein the fluid transfer system comprises at least one marine loading system.
